(19) United States
(12) Patent Application Publication
(10) Pub. No.: US 2026/0032224 A1
(43) Pub. Date: Jan. 29, 2026

(54) Head-Mounted Device with Context-Aware Graphics Rendering

(71) Applicant: Apple Inc., Cupertino, CA (US)

(72) Inventors: Milad Akhlaghi Bouzan, Redwood City, CA (US); Yashas Rai Kurlethimar, San Jose, CA (US); Dagny Fleischman, Campbell, CA (US)

(21) Appl. No.: 19/038,988

(22) Filed: Jan. 28, 2025

Related U.S. Application Data
(60) Provisional application No. 63/656,841, filed on Jun. 6, 2024.

(51) Int. Cl. H04N 13/122; H04N 13/383

(52) U.S. Cl. CPC H04N 13/122; H04N 13/383

(57) ABSTRACT

An electronic device such as a head-mounted device may include a renderer for generating virtual content, displays that generate light containing the virtual content, and optics that direct the light to eye boxes. The optics may include fixed lenses and optionally removable prescription lenses. The device may include gaze tracking sensors that measure eye position information at the eye boxes and that measure binocular gaze information between the eye boxes. The renderer may generate the virtual content according to a rendering configuration. The rendering configuration may be generated based on the eye position information, the binocular gaze information, hardware constraints of the optics, hardware constraints of the display, and/or information about the virtual content to be displayed. The renderer may render the virtual content with a peak resolution that exceeds a collective upper resolution limit of the optics and the display. The rendered virtual content may include foveated virtual content.

This application claims the benefit of U.S. Provisional Patent Application No. 63/656,841, filed Jun. 6, 2024, which is hereby incorporated by reference herein in its entirety.

### FIELD

This relates generally to electronic devices, including electronic devices with displays such as head-mounted devices.

### BACKGROUND

Electronic devices such as head-mounted devices can include near-eye displays for presenting virtual content to a user. It can be challenging to design a head-mounted device with near-eye displays that present virtual content to the user. If care is not taken, the head-mounted device can be excessively heavy or bulky, can exhibit insufficient levels of optical performance, or can consume excessive power.

### SUMMARY

An electronic device such as a head-mounted device may include a context-aware rendering configurer and a renderer for generating virtual content and one or more displays configured to generate light containing the virtual content. The device may include optics that direct the light to eye boxes. The optics may include fixed lenses and can optionally include removable prescription lenses. The device may include gaze tracking sensors that measure eye position information at the eye boxes and that measure binocular gaze information between the eye boxes.

The context-aware rendering configurer may generate a context-aware rendering configuration for the renderer to use in rendering the virtual content. The rendering configuration may be generated based on the eye position information, the binocular gaze information, hardware constraints of the optics, hardware constraints of the display, and/or information about the virtual content to be displayed. The renderer may render the virtual content with a peak resolution that exceeds a collective upper resolution limit of the optics and the display. The display and optics may degrade the peak resolution of the virtual content such that the virtual content is received at the eye boxes at a resolution less than or equal to the collective upper resolution limit. The rendered virtual content may include foveated virtual content having a foveated region and other characteristics that are selected based on the eye position information, the binocular gaze information, hardware constraints of the optics, hardware constraints of the display, and/or information about the virtual content to be displayed.

An aspect of the disclosure provides a method of operating an electronic device. The method can include with a gaze tracking sensor, generating eye position information associated with an eye box. The method can include with a renderer, rendering virtual content having a peak resolution based on the eye position information. The method can include with a display, generating light that includes the rendered virtual content. The method can include with optics, directing the light to the eye box, wherein the display and the optics collectively exhibit a resolution limit, the peak resolution exceeds the resolution limit, and the display and the optics decrease the peak resolution of the rendered virtual content to a magnitude at the eye box that is less than or equal to the resolution limit.

An aspect of the disclosure provides a method of operating an electronic device. The method can include with a gaze tracking sensor, identifying an eye relief associated with an eye box. The method can include with a renderer, rendering a frame of virtual content having a foveated region that is based on the eye relief, the foveated region having a resolution. The method can include with a display, generating light that includes the frame of virtual content. The method can include with optics, directing the light to the eye box, wherein the display and the optics collectively exhibit an upper resolution limit and wherein the resolution of the foveated region in the rendered frame of virtual content exceeds the upper resolution limit.

An aspect of the disclosure provides a method of operating an electronic device. The method can include with a display, generating light that includes a frame of virtual content, the frame of virtual content including a foveated region. The method can include with a lens, directing the light towards a removable prescription lens. The method can include with the removable prescription lens, directing the light towards an eye box. The method can include with a renderer, rendering the frame of virtual content based on one or more characteristics of the removable prescription lens, wherein the display, the lens, and the removable lens collectively exhibit an upper resolution limit. The method can include with the renderer, providing the rendered frame of virtual content to the display with a resolution in the foveated region that exceeds the upper resolution limit.

### BRIEF DESCRIPTION OF THE DRAWINGS

FIG. 1 is a top view of an illustrative head-mounted device in accordance with some embodiments.

FIG. 2 is a schematic diagram of an illustrative electronic device in accordance with some embodiments.

FIG. 3 is a diagram showing illustrative hardware and/or software subsystems within an electronic device configured to perform context-aware graphics rendering in accordance with some embodiments.

FIG. 4 is a diagram showing how eye position measured by an illustrative gaze tracking system may be defined using one or more degrees of freedom in accordance with some embodiments.

FIG. 5 is a diagram showing how binocular gaze information may be characterized by an illustrative gaze tracking system in accordance with some embodiments.

FIG. 6 is a diagram of an illustrative context-aware rendering configurer in accordance with some embodiments.

FIG. 7 is a diagram showing how an illustrative context-aware rendering configurer may output virtual content with different resolutions across the field of view of an eye box under different conditions in accordance with some embodiments.

FIG. 8 is a flow chart of illustrative operations for an electronic device of the type shown in connection with FIGS. 1-7 in accordance with some embodiments.

FIG. 9 is a flow chart of illustrative operations for a context-aware rendering configurer in accordance with some embodiments.

FIG. 10 is a diagram of resolution as a function of angle showing how an illustrative context-aware rendering configurer may output virtual content with a peak resolution beyond a hardware resolution limit in accordance with some embodiments.

### DETAILED DESCRIPTION

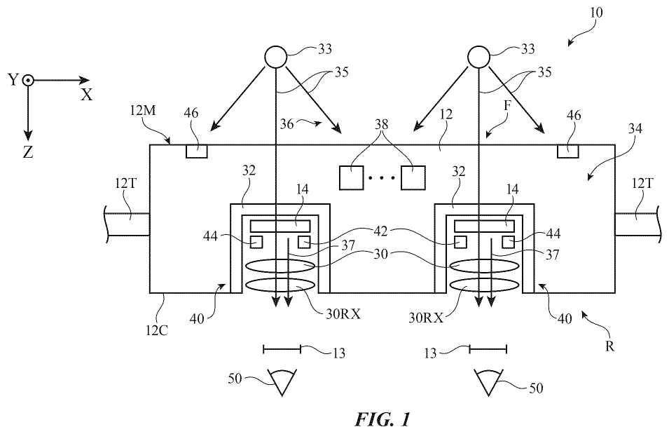

A top view of an illustrative head-mounted device is shown in FIG. 1. As shown in FIG. 1, head-mounted devices such as electronic device 10 may have head-mounted support structures such as housing 12. Housing 12 may include portions (e.g., head-mounted support structures 12T) to allow device 10 to be worn on a user's head. Support structures 12T may be formed from fabric, polymer, metal, and/or other material. Support structures 12T may form a strap or other head-mounted support structures to help support device 10 on a user's head. A main support structure (e.g., a head-mounted housing such as main housing portion 12M) of housing 12 may support electronic components such as displays 14.

Main housing portion 12M may include housing structures formed from metal, polymer, glass, ceramic, and/or other material. For example, housing portion 12M may have housing walls on front face F and housing walls on adjacent top, bottom, left, and right side faces that are formed from rigid polymer or other rigid support structures, and these rigid walls may optionally be covered with electrical components, fabric, leather, or other soft materials, etc. Housing portion 12M may also have internal support structures such as a frame (chassis) and/or structures that perform multiple functions such as controlling airflow and dissipating heat while providing structural support. In some implementations, housing portion 12M may include a conductive inner chassis or frame and a conductive outer chassis or frame that laterally surrounds the conductive inner chassis or frame.

The walls of housing portion 12M may enclose internal components 38 in interior region 34 of device 10 and may separate interior region 34 from the environment surrounding device 10 (exterior region 36). Internal components 38 may include integrated circuits, actuators, batteries, sensors, fans, and/or other circuits and structures for device 10. Housing 12 may be configured to be worn on a head of a user and may form glasses, spectacles, a hat, a mask, a helmet, goggles, and/or other head-mounted device. Configurations in which housing 12 forms goggles may sometimes be described herein as an example.

Front face F of housing 12 may face outwardly away from a user's head and face. Opposing rear face R of housing 12 may face the user. Portions of housing 12 (e.g., portions of main housing 12M) on rear face R may form a cover such as cover 12C (sometimes referred to as a curtain). The presence of cover 12C on rear face R may help hide internal housing structures, internal components 38, and other structures in interior region 34 from view by a user.

Device 10 may have one or more cameras such as cameras 46 of FIG. 1. Cameras 46 that are mounted on front face F and that face outwardly (towards the front of device 10 and away from the user) may sometimes be referred to herein as forward-facing or front-facing cameras. Cameras 46 may capture visual odometry information, image information that is processed to locate objects in the user's field of view (e.g., so that virtual content can be registered appropriately relative to real-world objects), image content that is displayed in real time for a user of device 10, and/or other suitable image data. For example, forward-facing (front-facing) cameras may allow device 10 to monitor movement of the device 10 relative to the environment surrounding device 10 (e.g., the cameras may be used in forming a visual odometry system or part of a visual inertial odometry system). Forward-facing cameras may also be used to capture images of the environment that are displayed to a user of the device 10. If desired, images from multiple forward-facing cameras may be merged with each other and/or forward-facing camera content can be merged with computer-generated content for a user.

Image content captured by cameras 46 may include images of real-world objects 33 (sometimes also referred to herein as external objects 33). Real-world objects 33 may include animate objects, inanimate objects, landscape features, obstacles, furniture, external devices, buildings, scenery, fixtures, body parts of the user of device 10, and/or any other objects around and/or in front of device 10. The images of real-world objects 33 may include image data generated by cameras 46 in response to the receipt of light from real-world objects 33 such as world light 35. World light 35 may be emitted by, reflected by, and/or scattered off of one or more real-world objects 33. World light 35 is sometimes also referred to herein as scene light 35, ambient light 35, environmental light 35, external light 35, or exterior light 35.

Device 10 may have any suitable number of cameras 46. For example, device 10 may have K cameras, where the value of K is at least one, at least two, at least four, at least six, at least eight, at least ten, at least 12, less than 20, less than 14, less than 12, less than 10, 4-10, or other suitable value. Cameras 46 may be sensitive at infrared wavelengths (e.g., cameras 46 may be infrared cameras), may be sensitive at visible wavelengths (e.g., cameras 46 may be visible cameras), and/or cameras 46 may be sensitive at other wavelengths. If desired, cameras 46 may be sensitive at both visible and infrared wavelengths.

Device 10 may have left and right optical modules 40. Optical modules 40 support electrical and optical components such as light-emitting components and lenses and may therefore sometimes be referred to as optical assemblies, optical systems, optical component support structures, lens and display support structures, electrical component support structures, or housing structures. Each optical module may include a respective display 14, lens 30, and support structure such as support structure 32. Support structure 32, which may sometimes be referred to as a lens support structure, optical component support structure, optical module support structure, or optical module portion, or lens barrel, may include hollow cylindrical structures with open ends or other supporting structures to house displays 14 and lenses 30. Support structures 32 may, for example, include a left lens barrel that supports a left display 14 and left lens 30 and a right lens barrel that supports a right display 14 and right lens 30.

Displays 14 may include arrays of pixels or other display devices to produce images in image light 37. Displays 14 may, for example, include organic light-emitting diode pixels formed on substrates with thin-film circuitry and/or formed on semiconductor substrates, pixels formed from crystalline semiconductor dies, liquid crystal display pixels, scanning display devices, and/or other display devices for producing images in image light 37. Image light 37 may be, for example, visible light (e.g., including wavelengths from 400-700 nm) that contains and/or represents something viewable such as a scene or object (e.g., virtual content as modulated onto the image light using image data provided by control circuitry to the array of pixels).

Lenses 30 may include one or more lens elements for providing image light from displays 14 to respective eyes boxes 13. Lenses may be implemented using refractive glass lens elements, using mirror lens structures (catadioptric lenses), using Fresnel lenses, using holographic lenses, and/or other lens systems. Surfaces of lenses 30 may be convex, concave, freeform curved, planar, etc.

If desired, device 10 may also include prescription lenses 30RX (e.g., optically coupled between lenses 30 and eye boxes 13). Prescription lenses 30RX may transmit image light 37 to eye boxes 13. If desired, prescription lenses 30RX may be removable from device 10 (e.g., may be removably attached to support structures 32). Removable lenses that are used on a given device 10 may be selected to provide vision correction specific for a particular user (e.g., a user with a particular eyeglass prescription may attach left and right removable lenses such as prescription lenses 30RX to respective left and right optical modules 40 to correct for vision defects such as refractive errors in the user's left and right eyes). Prescription lenses 30RX (sometimes also referred to herein as prescription lens elements) are optically configured to correct for the user's vision defects and thereby allow a user to view images in image light 37 clearly when prescription lenses 30RX are mounted in alignment with fixed lenses such as lenses 30.

In implementations where device 10 is an augmented reality (AR) device such as a pair of AR glasses, displays 14 may include one or more optical combiners that redirect image light 37 towards eye boxes 13 and that concurrently transmit world light 35 from real-world objects 33 to eye boxes 13 (e.g., through lenses 30 and optionally through prescription lenses 30RX). The optical combiners may serve to overlay world light 35 with virtual content (e.g., virtual objects) in image light 37. In these implementations, displays 14 may include projectors and waveguides, for example. The projectors may output image light 37 and the waveguides may redirect the image light towards the eye boxes through lenses 30 and optionally through prescription lenses 30RX. The waveguide may include optical couplers with diffractive gratings, louvered mirrors, and/or prisms if desired. The projectors may, for example, include spatial light modulators such as liquid crystal on silicon (LCOS) display panels or digital-micromirror device (DMD) display panels that generate image light 37 by modulating image data onto illumination light. In other implementations, the projectors may include emissive display panels such as uLED panels that emit image light 37.

When a user's eyes are located in eye boxes 13, displays 14 (e.g., left and right display panels) operate together to form a display for device 10 (e.g., the images provided by respective left and right optical modules 40 may be viewed by the user's eyes in eye boxes 13 so that a stereoscopic image is created for the user). The left image from the left optical module fuses with the right image from a right optical module while the display is viewed by the user.

It may be desirable to monitor the user's eyes while the user's eyes are located in eye boxes 13. For example, it may be desirable to use a camera to capture images of the user's irises (or other portions of the user's eyes) for user authentication. It may also be desirable to monitor the position of the user's eyes at eye boxes 13. This may include monitoring the direction of the user's gaze (sometimes also referred to herein as gaze direction) and/or monitoring the spatial location of the user's pupils. Device 10 may include a gaze tracking sensor that measures the position of the user's eyes at eye boxes 13 over time. The gaze tracking sensor may generate gaze tracking information (sometimes also referred to herein as eye position information) that identifies, includes, or characterizes the position of the user's eyes at eye boxes 13. If desired, the gaze tracking information may be used as a form of user input and/or may be used to determine where, within an image, image content resolution should be locally enhanced in a foveated imaging system.

To ensure that device 10 can capture satisfactory eye images while a user's eyes are located in eye boxes 13, each optical module 40 may be provided with a camera such as camera 42 and one or more light sources such as light-emitting diodes 44 or other light-emitting devices such as lasers, lamps, etc. Cameras 42 and light-emitting diodes 44 may operate at any suitable wavelengths (visible, infrared, and/or ultraviolet). As an example, diodes 44 may emit infrared light that is invisible (or nearly invisible) to the user. This allows eye monitoring operations to be performed continuously without interfering with the user's ability to view images on displays 14. Cameras 42 and light-emitting diodes 44 may collectively form part of a gaze tracking sensor or system in device 10.

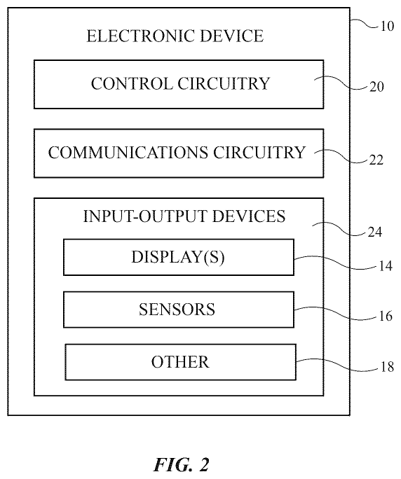

A schematic diagram of device 10 is shown in FIG. 2. Device 10 of FIG. 2 may be operated as a stand-alone device and/or the resources of device 10 may be used to communicate with external electronic equipment. As an example, communications circuitry in device 10 may be used to transmit user input information, sensor information, and/or other information to external electronic devices (e.g., wirelessly or via wired connections). Each of these external devices may include components of the type shown by device 10 of FIG. 2.

As shown in FIG. 2, a head-mounted device such as device 10 may include control circuitry 20. Control circuitry 20 may include storage and processing circuitry for supporting the operation of device 10. The storage and processing circuitry may include storage such as nonvolatile memory (e.g., flash memory or other electrically-programmable-read-only memory configured to form a solid state drive), volatile memory (e.g., static or dynamic random-access-memory), etc. One or more processors in control circuitry 20 may be used to gather input from sensors and other input devices and may be used to control output devices. The processing circuitry may be based on one or more processors such as microprocessors, microcontrollers, digital signal processors, baseband processors and other wireless communications circuits, power management units, audio chips, central processing units (CPUs), graphics processing units (GPUs), application specific integrated circuits, etc. During operation, control circuitry 20 may use display(s) 14 and other output devices in providing a user with visual output and other output. Control circuitry 20 may be configured to perform operations in device 10 using hardware (e.g., dedicated hardware or circuitry), firmware, and/or software. Software code for performing operations in device 10 may be stored on storage circuitry (e.g., non-transitory (tangible) computer readable storage media that stores the software code). The software code may sometimes be referred to as program instructions, software, data, instructions, or code. The stored software code may be executed by the processing circuitry within circuitry 20.

To support communications between device 10 and external equipment, control circuitry 20 may communicate using communications circuitry 22. Communications circuitry 22 may include antennas, radio-frequency transceiver circuitry, and other wireless communications circuitry and/or wired communications circuitry. Communications circuitry 22, which may sometimes be referred to as control circuitry and/or control and communications circuitry, may support bidirectional wireless communications between device 10 and external equipment (e.g., a companion device such as a computer, cellular telephone, or other electronic device, an accessory such as a point device or a controller, computer stylus, or other input device, speakers or other output devices, etc.) over a wireless link.

For example, communications circuitry 22 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link. Wireless communications may, for example, be supported over a Bluetooth® link, a WiFi® link, a wireless link operating at a frequency between 10 GHz and 400 GHz, a 60 GHz link, a cellular telephone link (e.g., a 4G link, a 5G link, a 6G link at sub-THz frequencies between around 100 GHz and around 10 THz, etc.), a wireless local area network WLAN) link, or other millimeter wave link, or other wireless communications link. Device 10 may, if desired, include power circuits for transmitting and/or receiving wired and/or wireless power and may include batteries or other energy storage devices. For example, device 10 may include a coil and rectifier to receive wireless power that is provided to circuitry in device 10.

Device 10 may include input-output devices such as devices 24. Input-output devices 24 may be used in gathering user input, in gathering information on the environment surrounding the user, and/or in providing a user with output. Devices 24 may include one or more displays such as display(s) 14. Display(s) 14 may include one or more display devices such as organic light-emitting diode display panels (panels with organic light-emitting diode pixels formed on polymer substrates or silicon substrates that contain pixel control circuitry), liquid crystal display panels, microelectromechanical systems displays (e.g., two-dimensional mirror arrays or scanning mirror display devices), display panels having pixel arrays formed from crystalline semiconductor light-emitting diode dies (sometimes referred to as microLEDs (uLEDs)), LCOS display panels, DMD display panels, and/or other display devices.

Sensors 16 in input-output devices 24 may include force sensors (e.g., strain gauges, capacitive force sensors, resistive force sensors, etc.), audio sensors such as microphones, touch and/or proximity sensors such as capacitive sensors such as a touch sensor that forms a button, trackpad, or other input device), and other sensors. If desired, sensors 16 may include optical sensors such as optical sensors that emit and detect light, ultrasonic sensors, optical touch sensors, optical proximity sensors, and/or other touch sensors and/or proximity sensors, monochromatic and color ambient light sensors, image sensors (e.g., cameras), fingerprint sensors, iris scanning sensors, retinal scanning sensors, and other biometric sensors, temperature sensors, sensors for measuring three-dimensional non-contact gestures (“air gestures”), pressure sensors, sensors for detecting position, orientation, and/or motion of device 10 and/or information about a pose of a user's head (e.g., accelerometers, magnetic sensors such as compass sensors, gyroscopes, and/or inertial measurement units that contain some or all of these sensors), health sensors such as blood oxygen sensors, heart rate sensors, blood flow sensors, and/or other health sensors, radio-frequency sensors, three-dimensional camera systems such as depth sensors (e.g., structured light sensors and/or depth sensors based on stereo imaging devices that capture three-dimensional images) and/or optical sensors such as self-mixing sensors and light detection and ranging (lidar) sensors that gather time-of-flight measurements (e.g., time-of-flight cameras), humidity sensors, moisture sensors, gaze tracking sensors, electromyography sensors to sense muscle activation, facial sensors, and/or other sensors. In some arrangements, device 10 may use sensors 16 and/or other input-output devices to gather user input. For example, buttons may be used to gather button press input, touch sensors overlapping displays can be used for gathering user touch screen input, touch pads may be used in gathering touch input, microphones may be used for gathering audio input (e.g., voice commands), accelerometers may be used in monitoring when a finger contacts an input surface and may therefore be used to gather finger press input, etc.

If desired, electronic device 10 may include additional components (see, e.g., other devices 18 in input-output devices 24). The additional components may include haptic output devices, actuators for moving movable housing structures, audio output devices such as speakers, light-emitting diodes for status indicators, light sources such as light-emitting diodes that illuminate portions of a housing and/or display structure, other optical output devices, and/or other circuitry for gathering input and/or providing output. Device 10 may also include a battery or other energy storage device, connector ports for supporting wired communication with ancillary equipment and for receiving wired power, and other circuitry.

Display(s) 14 can be used to present a variety of content to a user's eye. The left and right displays 14 that are used to present a fused stereoscopic image to the user's eyes when viewing through eye boxes 13 can sometimes be referred to collectively as a display 14. As an example, virtual reality (VR) content can be presented by display 14. Virtual reality content may refer to content that only includes virtual content (e.g., virtual objects) within a virtual reality (computer-generated) environment. As another example, mixed reality (MR) content can be presented by display 14. Mixed reality content may refer to content that includes virtual objects and real objects from the real-world physical environment in which device 10 is being operated (see, e.g., real-world objects 35 of FIG. 1). As another example, only real-world content can be presented by display 14. The real-world content may refer to images being captured by one or more front-facing cameras (see, e.g., cameras 46 in FIG. 1) and passed through as a live feed to the user. The real-world content being captured by the front-facing cameras is therefore sometimes referred to as a camera passthrough feed, a (live) video passthrough feed, or a passthrough video feed (stream).

In general, increasing the physical size of displays 14 will increase the maximum resolution of the images that can be displayed using image light 37. However, space is often at a premium in compact systems such as device 10. To provide high resolution images without undesirably burdening the resources of system 10 and without further increasing the size of displays 14, displays 14 may be configured to perform dynamic foveation on the virtual content included in image light 37. Displays 14 may, for example, display portions of an image that are near the center of the user's field of view with higher resolution, whereas portions of the image that are far from the center of the user's field of view are displayed with lower resolution. As the user's gaze direction changes over time, displays 14 may adjust the portions of the image that are produced with the higher resolution so that that portion remains at the center of the user's gaze. Gaze tracking sensors on device 10 may actively track the location of the user's gaze over time. Information about the direction of the user's gaze may be used to shift the location of the higher resolution portion of the image to follow the center of the user's gaze.

In this way, images in image light 37 may be foveated images if desired (e.g., dynamically foveated images in which the higher resolution portions of the image are re-located over time to follow/track the user's gaze). Foveated images in image light 37 may include a higher resolution region having relatively high resolution (sometimes referred to herein as a foveal region, foveated region, foveal zone, foveated zone, high resolution zone, high resolution region, or high resolution zone) and one or more lower resolution regions lower resolution(s) than the foveated region (sometimes also referred to herein as a peripheral region, peripheral zone, low resolution region, or low resolution zone).

The resolution of different regions of the foveated images may be characterized by a resolution metric such as pixels per degree (PPD). The foveated images may include virtual content such as one or more virtual objects. The resolution of the virtual content may vary as a function of angle within the field of view (FOV) of image light 37 (e.g., where portions of the virtual content in a foveated zone of the foveated image have higher resolution than portions of the virtual content in a peripheral zone of the foveated image). The resolution of the foveated images may vary in any desired manner (e.g., smoothly, gradually, sharply, etc.) between the foveated region and the peripheral region (e.g., according to a corresponding foveation curve or profile). If desired, pixel grouping schemes may be used in generating the peripheral regions of foveated images (e.g., where the same pixel value is applied across groups of adjacent pixels in the low resolution region(s) of the foveated images to conserve resources).

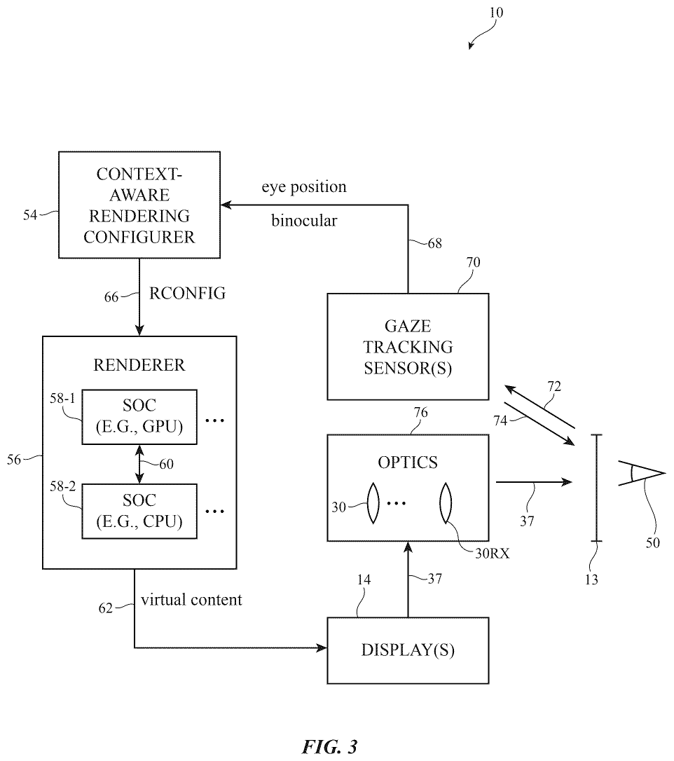

In practice, the optimal configuration for the foveated images may change over time based on one or more conditions or characteristics associated with device 10. The optimal configuration may, for example, be context-dependent and may depend on one or more operating parameters of device 10, information about the position of the user's eyes, and/or the virtual content to be displayed at eye boxes 13, which can change over time. If desired, device 10 may include rendering circuitry that renders virtual content (sometimes also referred to herein as virtual objects, computer generated objects, graphics, or computer generated graphics) to be displayed in image light 37 in a context-aware manner. In accordance with some embodiments, device 10 may be provided with software and/or hardware subsystems configured to perform context-aware rendering of foveated images to be displayed at eye boxes 13 in image light 37. An example of this type of device 10 is illustrated in FIG. 3.

As shown in FIG. 3, device 10 may include a context-aware rendering configuration subsystem such as context-aware rendering configurer 54 and a graphics (virtual) content rendering subsystem such as renderer 56. Context-aware rendering configurer 54 and renderer 56 supply rendered virtual content (e.g., rendered images of virtual objects) to display(s) 14. Display(s) 14 may generate image light 37 that includes the rendered virtual content (e.g., image data 37 may include a series of rendered frames of image data containing virtual content such as pixel values associated with one or more virtual objects). Optics 76 may direct, redirect, and/or focus image light 37 onto eye boxes 13. Optics 76 may include one or more lenses 30 (e.g., fixed lenses) and, if desired, may include one or more prescription lenses 30RX (e.g., removable user-specific prescription lenses) that direct, redirect, and/or focus image light 37 onto eye boxes 13. Optics 76 is sometimes also referred to herein as optical system 76 or optical stack 76.

Device 10 may include one or more gaze tracking sensors 70. Gaze tracking sensor(s) 70 may measure the position of eye 50 at, around, adjacent, and/or overlapping eye box 13. Device 10 may include a single context-aware rendering configurer 54, a single renderer 56, and/or a single gaze tracking sensor 70 for both the left and right displays 14 and eye boxes 13 in device 10 (FIG. 1) or may include different respective context-aware rendering configurers 54, renderers 56, and/or gaze tracking sensors 70 for each of the left and right displays 14 and eye boxes 13 in device 10.

Gaze tracking sensor(s) 70 may gather eye position information indicative of the position and/or orientation of eye 50. Gaze tracking sensor(s) 70 may include, for example, one or more light-emitting diodes 44 (FIG. 1) that emits sensing light 74 towards eye box 13. Gaze tracking sensor(s) 70 may emit sensing light 74 directly towards eye box 13 or, if desired, some or all of optics 76 may redirect sensing light 74 towards eye box 13. Sensing light 74 may be at non-visible wavelengths such as infrared and/or near-infrared wavelengths. Sensing light 74 may reflect off one or more portions of eye 50 as reflected light 72 (e.g., a reflected version of sensing light 74). Gaze tracking sensor(s) 70 may include one or more cameras 42 (FIG. 1) that receive reflected light 72 and that generate image sensor data in response to reflected light 72. Gaze tracking sensor(s) 70 may generate gaze tracking sensor data based on and/or including the generated image sensor data. One or more processors in device 10 may generate eye position information for eye 50 at/around eye box 13 based on the generated image sensor data. The eye position information may include a spatial position of eye 50 along one, two, or three orthogonal spatial axes and/or may include a gaze direction indicative of the angular direction of eye 50 (e.g., a gaze vector or point-of-gaze information). Gaze tracking sensor(s) 70 may transmit the eye position information to context-aware rendering configurer 54 over sensor data path 68.

If desired, the eye position information may also include information identifying the user's pupil size, may be used in monitoring the current focus of the lenses in the user's eyes (e.g., whether the user is focusing in the near field or far field, which may be used to assess whether a user is day dreaming or is thinking strategically or tactically), and/or other gaze information. Cameras in gaze tracking sensor(s) 70 (e.g., cameras 42 of FIG. 1) are sometimes also referred to herein as inward-facing cameras, gaze-detection cameras, eye-tracking cameras, gaze-tracking cameras, or eye-monitoring cameras. If desired, gaze tracking sensor(s) 70 may include binocular gaze information associated with the binocular alignment between the user's left eye 50 at a left eye box 13 and the user's right eye 50 at a right eye box 13. Gaze tracking sensor(s) 70 may transmit the binocular gaze information to context-aware rendering configurer 54 over sensor data path 68.

Context-aware rendering configurer 54 is sometimes also referred to herein as context-aware rendering configuration generator 54, context-aware rendering configuration engine 54, context-aware rendering configuration circuitry 54, context-aware rendering configuration subsystem 54, or context-aware rendering configuration block 54. Context-aware rendering configurer 54 may generate a context-aware rendering configuration RCONFIG based on eye position information from gaze tracking sensor(s) 70, binocular gaze information from gaze tracking sensor(s) 70, content to be rendered by renderer 56, and/or other hardware constraints. Context-aware rendering configurer 54 may transmit context-aware rendering configuration RCONFIG to renderer 56 over control path 66.

Render 56 is sometimes also referred to herein as graphics or virtual content rendering circuitry 56, graphics or virtual content rendering engine 56, graphics or virtual content rendering pipeline 56, graphics or virtual content rendering block 56, graphics renderer 56, virtual content renderer 56, or virtual object renderer 56. Renderer 56 may be configured, using context-aware rendering configuration RCONFIG, to render or generate virtual content (e.g., virtual reality content, augmented reality content, mixed reality content, or extended reality content including one or more rendered frames of pixel values that represent one or more virtual or computer-generated objects or graphics) and/or to carry out other graphics processing functions. In some implementations that are described herein as an example, the virtual content may be foveated virtual content that is foveated based on context-aware rendering configuration RCONFIG (e.g., the virtual content may include one or more foveated frames or frames of foveated image data).

Renderer 56 may transmit the virtual content (e.g., foveated virtual content) to display(s) 14 over data path 62. Display(s) 14 may include one or more pixel pipelines and/or display panels that generate image light 37 based on (including) the virtual content received over data path 62. In general, the components of context-aware rendering configurer 54 and/or renderer 56 may be implemented using hardware (e.g., one or more processors, storage circuitry, one or more systems on chip (SOCs), digital logic gates, analog logic, etc.) and/or software (e.g., as stored on storage circuitry and executed by one or more processors). Renderer 56 may include a set of one or more SOCs 58 such as at least a first SOC 58-1 and a second SOC 58-2. While illustrated as separate from renderer 56 for the sake of clarity, some or all of context-aware rendering configurer 54 may be implemented on and/or may be executed by SOC 58-1 and/or SOC 58-2 if desired.

One or more of the SOCs 58 of renderer 56 may, for example, synthesize photorealistic or non-photorealistic images from one or more 2-dimensional or 3-dimensional model(s) defined in a scene file that contains information on how to simulate a variety of features such as information on shading (e.g., how color and brightness of a surface varies with lighting), shadows (e.g., how to cast shadows across an object), texture mapping (e.g., how to apply detail to surfaces), reflection, transparency or opacity (e.g., how light is transmitted through a solid object), translucency (e.g., how light is scattered through a solid object), refraction and diffraction, depth of field (e.g., how certain objects can appear out of focus when outside the depth of field), motion blur (e.g., how certain objects can appear blurry due to fast motion), and/or other visible features relating to the lighting or physical characteristics of objects in a scene. Renderer 56 may apply rendering algorithms such as rasterization, ray casting, ray tracing, radiosity, or other graphics processing algorithms if desired.

As one example, SOC 58-1 may include one or more processors such as a GPU and SOC 58-2 may include one or more processors such as a CPU. In this implementation, SOC 58-1 may, for example, perform graphics rendering, composition, and/or other rendering operations whereas SOC 58-2 performs geometrical corrections to the rendered graphics (e.g., warping, morphing, rippling, deformations, distortions, and/or other transformations or visual effects to the underlying images). These processes may be distributed across more than two SOCs, CPUs, and/or GPUs if desired.

SOC 58-1 may be coupled to SOC 58-2 by an inter-SOC communication link, path, or bus such as inter-SOC channel 60. Inter-SOC channel 60 may exhibit a hardware constraint such as a limited bandwidth. The limited bandwidth may impose an upper limit on the total number of pixels that can be transferred between SOC 58-1 and SOC 58-2 per frame. A memory bandwidth limit may, for example, be designed to satisfy a final content delivery resolution given the system impulse response.

Generating virtual content as foveated virtual content may help to optimize the display rendering process by allocating more computational resources to a region of the display aligned with the user's point of gaze while reducing the detail in the peripheral regions not aligned with the user's point of gaze (e.g., by locally enhancing the image resolution of the video feed only in the area of the user's gaze). Since the area or point of gaze can vary over time, foveation can be performed dynamically at a rate sufficient to keep up with the drift of the user's gaze (e.g., as tracked using gaze tracking sensor(s) 70). Renderer 56 may, for example, be configured (e.g., using context-aware rendering configuration RCONFIG) to generate a foveation curve and a desired display pixel grouping based on the received gaze information for locally enhancing the image resolution of the video feed in the area of the user's gaze.

In practice, the optimal rendering configuration utilized by renderer 56 to generate foveated virtual content can depend upon a number of factors such as eye position, the data/content to be rendered, and/or hardware constraints. In addition, the hardware and/or software between renderer 56 and the eye box can exhibit one or more constraints that physically deteriorate the resolution of rendered images in image light 37 by the time the image light is viewed at eye boxes 13. Examples of such constraints include hardware and/or software constraints (e.g., maximum resolution limits) of display(s) 14, hardware constraints of optics 76 (e.g., lenses 30 and/or 30RX), hardware and/or software constraints of corrective processing circuitry (e.g., software and/or hardware pipelines) that operates on the rendered virtual content output by renderer 56 (e.g., lens distortion corrections, color corrections, point of view corrections, brightness corrections, perceptual latency corrections such as late stage warp/re-projection), and/or hardware/software constraints associated with MR integration corrections or augmentations (e.g., applying noise, sharpness, coloration, blur, etc., to match camera frames) and/or MR blending (e.g., blending of VR content with camera passthrough images). If care is not taken, the peak resolution of the rendered virtual content output by renderer 56 can be deteriorated by these constraints, such that the virtual content is actually provided to eye box 13 with a peak resolution that is below an upper limit supported by the hardware and software of system 10.

For example, hardware and/or software between renderer 56 and display(s) 14, display(s) 14, and/or optics 76 may collectively support or exhibit a peak resolution of X PPD for virtual content as viewed at eye box 13, but that physically deteriorates the resolution of virtual content received from renderer 56 by Y PPD (e.g., during the processing of the rendered content, generation of image light 37, and delivery of image light 37 to eye box 13). In this example, if renderer 56 outputs foveated virtual content having a peak resolution of X PPD to match the peak resolution supported by the hardware of display(s) 14 and optics 76, the Y PPD deterioration introduced by display(s) 14 and optics 76 will cause the virtual content to actually be received at eye box 13 with a peak resolution of (X-Y) PPD, which is below the maximum of X PPD supported by the hardware of display(s) 14 and optics 76.

To mitigate these issues, context-aware rendering configurer 54 may generate a context-aware rendering configuration RCONFIG that configures renderer 56 to generate foveated virtual content having a boosted peak resolution that actually exceeds the upper resolution limit of the hardware/software between renderer 56 and eye box 13 by a predetermined margin. The predetermined margin may be sufficiently large such that any deterioration in resolution produced by the hardware/software between renderer 56 and eye box 13 is reversed or canceled out by the time image light 37 is received at eye box 13, allowing eye box 13 to receive image light 37 at the actual upper resolution limit exhibited by the hardware/software between renderer 56 and eye box 13. In the example above where the hardware and software between renderer 56 and eye boxes 13 deteriorate resolution by Y PPD and exhibit an upper limit on resolution of X PPD, renderer 56 may, for example, generate foveated virtual content having a peak resolution of Z≥(X+Y) PPD. Then, the Y PPD deterioration produced by the hardware/software between renderer 56 and eye box 13 will reduce the peak resolution of the virtual content to (Z-Y) PPD, which is greater than or equal to X PPD by the time the virtual content is received at eye box 13. This is higher than the peak resolution in situations where renderer 56 does not generate foveated virtual content having a boosted peak resolution that exceeds the upper resolution limit supported by the hardware/software between renderer 56 and eye box 13 (e.g., hardware/software pipeline constraints, hardware/software constraints of display(s) 14, and hardware constraints of optics 76).

In practice, the hardware constraints imposed by hardware/software between renderer 56 and eye box 13 on the resolution of foveated virtual content depends on contextual information such as eye position, whether or not optics 76 include prescription lens 30RX, and the content to be rendered itself. Context-aware rendering configurer 54 may generate context-aware rendering configuration RCONFIG in a manner that configures renderer 56 to generate virtual content (e.g., foveated virtual content) with as high a peak resolution as possible given this contextual information while minimizing power consumption, even as the operating conditions of device 10 change over time.

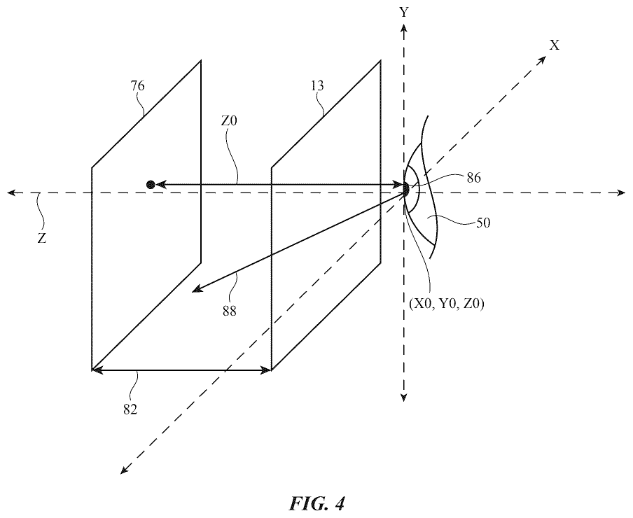

FIG. 4 is a diagram showing how eye position information generated by gaze tracking sensor(s) 70 may identify or characterize the position of eye 50 at eye box 13. As shown in FIG. 4, eye box 13 may be located at a fixed nominal distance 82 from optics 76 (e.g., from a last optical surface of optics 76 that interacts with image light 37 while directing image light 37 to eye box 13, such as a user-facing surface of lens 30 or prescription lens 30RX of FIGS. 1 and 3). Fixed nominal distance 82 is sometimes also referred to herein as the default or nominal eye relief of eye box 13. When the user wears device 10, the user's eye 50 may be located at, within, adjacent to, and/or overlapping eye box 13. The position and/or orientation of eye 50 may be characterized by one or more degrees of freedom.

For example, the spatial position of eye 50 may be characterized by a spatial position X0 along axis X, a spatial position Y0 along axis Y orthogonal to axis X, and a spatial position Z0 along axis Z orthogonal to axes X0 and Y0. Axis Z may, for example, extend from optics 76 to eye box 13 (e.g., may lie within a plane normal to eye box 13 and/or the last optical surface of optics 76). Spatial positions along axis X characterize the horizontal position of the pupil 86 of eye 50. Spatial positions along axis Y characterize the vertical position of pupil 86. Spatial positions along axis Z characterize the eye relief (ER) of pupil 86 or eye 50 (e.g., where the eye relief of pupil 86 is defined by the lateral separation of pupil 86 from the last optical surface of optics 76, along the shortest line or the normal line between position (X0, Y0) and the last optical surface of optics 76). The spatial position Z0 of eye 50 is sometimes also referred to herein as eye relief Z0.

In some situations, eye relief Z0 may be the same as nominal distance 82 (e.g., when pupil 86 lies within the surface of eye box 13). However, in practice, eye relief Z0 may be different than nominal distance 82, because the user will not always place eye 50 at nominal distance 82 from optics 76 while wearing device 10. In addition, adjustments to support structures and/or alignment structures on device 10, the addition of a prescription lens 30RX, and/or user-to-user or instance-to-instance variation in how the user wears device 10 can cause eye relief Z0 to differ by different amounts from nominal distance 82 at different times.

The orientation (gaze direction) of eye 50 may be characterized by a gaze vector 88. Gaze vector 88 may be defined using spherical coordinates (e.g., having an elevation angle relative to the X-Y plane and an azimuthal angle around axis Z) or any other desired coordinate scheme. Gaze vector 88 may also be defined by a point-of-gaze (e.g., a point in a plane parallel to the X-Y plane or in a surface parallel to eye box 13 that intersects gaze vector 88). The eye position information generated by gaze tracking sensor(s) 70 (FIG. 3) may include or identify one or more of gaze vector 88, spatial position X0, spatial position Y0, and eye relief Z0. Changes in one or more of gaze vector 88, spatial position X0, spatial position Y0, and eye relief Z0 may cause corresponding changes in the foveation profile of foveated virtual content produced by renderer 56 (e.g., changes in the location/shape of the foveated region, changes in how sharply resolution varies as a function of position across frames of foveated image data, etc.). For example, the location, shape, and/or size of the foveated region of the foveated virtual content rendered by renderer 56 may depend on gaze direction in addition to one or more of spatial position X0, spatial position Y0, and eye relief Z0. Context-aware rendering configurer 54 may generate context-aware rendering configuration RCONFIG based on or more of gaze vector 88, spatial position X0, spatial position Y0, and eye relief Z0 to configure renderer 56 to render foveated virtual content that is optimal for the current eye position in at least three dimensions.

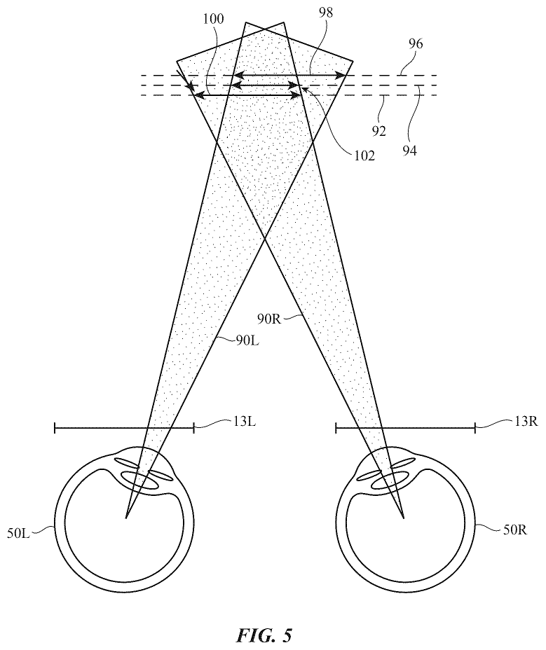

Gaze tracking sensor(s) 70 (FIG. 3) may also generate binocular gaze information associated with the gaze vector 88 for both the left and right eye boxes 13. FIG. 5 is a diagram showing an example of binocular gaze information that may be generated by gaze tracking sensor(s) 70. As shown in FIG. 5, a user's left eye 50L may overlap left eye box 13L and the user's right eye 50R may overlap right eye box 13R.

In some implementations, dynamic foveation and pixel grouping are monocular features that are separately performed for the image light 37 provided to each eye. If desired, the renderer may take advantage of binocular gaze tracking to more efficiently distribute available bandwidth. Left eye 50L may have a gaze oriented in the direction of region 90L. Right eye 50R may have a gaze oriented in the direction of region 90R. Region 90R may exhibit a monocular uncertainty zone 100 at plane 92 (e.g., a spatial or angular zone of uncertainty in determining the gaze direction of right eye 50R). Region 90L may exhibit a monocular uncertainty zone 98 at plane 96 parallel to plane 92 (e.g., a spatial or angular zone of uncertainty in determining the gaze direction of left eye 50L).

Monocular uncertainty zone 98 overlaps monocular uncertainty zone 100 within a binocular uncertainty zone 102 in a plane 94 parallel to and between planes 92 and 96. Binocular uncertainty zone 102 is smaller than each of monocular uncertainty zones 98 and 100. As such, by identifying and processing both the both left and right eye gaze directions, a binocular uncertainty zone 102 can be achieved that is smaller than each eye's individual monocular uncertainty zone. Renderer 56 may, for example, generate a foveated region (e.g., a region of peak resolution) that overlaps the user's binocular uncertainty zone 102 as detected using gaze tracking sensor(s) 70 (FIG. 3) without detriment to user experience, which can consume less bandwidth and power than generating two larger foveated regions for the left and right eye overlapping monocular uncertainty zone 98 and monocular uncertainty zone 100 respectively.

Changes in binocular uncertainty zone 102 may cause corresponding changes in the foveation profile of foveated virtual content produced by renderer 56 (e.g., changes in the location/shape of the foveated region, changes in how sharply resolution varies as a function of position across frames of foveated image data, etc.). For example, the location, shape, and/or size of the foveated region of the foveated virtual content rendered by renderer 56 may depend on the location, shape, and/or size of binocular uncertainty zone 102. Context-aware rendering configurer 54 may generate context-aware rendering configuration RCONFIG based on the location, shape, and/or size of binocular uncertainty zone 102 if desired. Gaze tracking sensor(s) 70 may transmit information about the location, shape, and/or size of binocular uncertainty zone 102 and/or any other desired binocular gaze information gathered from both eye boxes 13L and 13R to context-aware rendering configurer for use in generating context-aware rendering configuration RCONFIG.

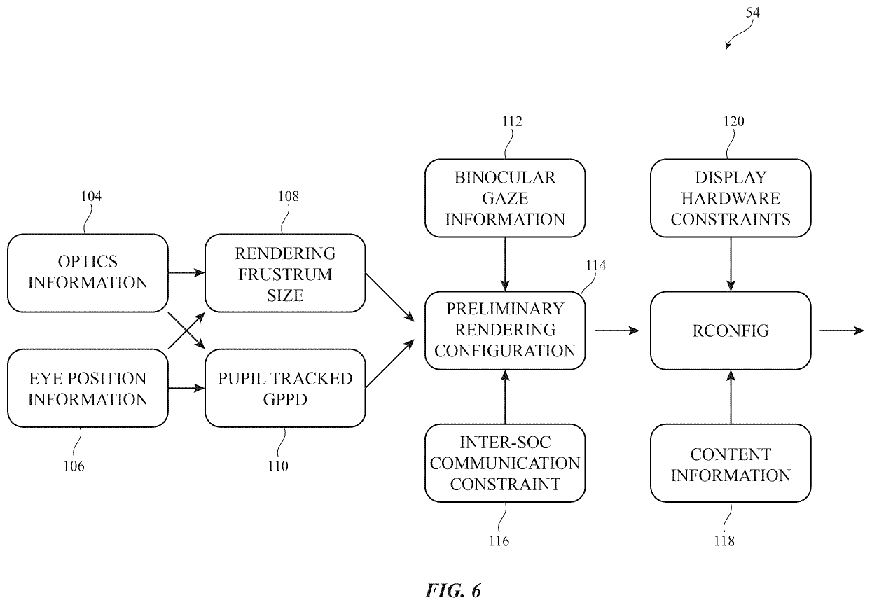

FIG. 6 is a diagram illustrating how context-aware rendering configurer 54 may generate an optimal context-aware rendering configuration RCONFIG for renderer 56 to use in generating a corresponding frame of foveated virtual content based on information from gaze tracking sensors 70, information about the content to be displayed, and/or hardware constraints associated with device 10. The elements of FIG. 6 may be received, identified, obtained, retrieved, processed, generated, calculated, computed, produced, and/or output by software and/or hardware on device 10 (e.g., digital logic and/or one or more processors within and/or implementing context-aware rendering configurer 54).

As shown in FIG. 6, context-aware rendering configurer 54 may receive eye position information 106 from gaze tracking sensor(s) 70 over sensor data path 68 of FIG. 3. Eye position information 106 may include orientation and/or spatial information associated with eye 50 and/or pupil 86 (e.g., spatial position X0, spatial position Y0, eye relief Z0, and/or gaze vector 88 of FIG. 4).

Context-aware rendering configurer 54 may also receive or identify optics information 104. Optics information 104 may include information about one or more hardware characteristics, optical characteristics, and/or constraints of optics 76, including lenses 30 and/or prescription optics 30RX (FIGS. 1 and 3). Optics information 104 may include lens profiles for lenses 30 and/or prescription lenses 30RX, information identifying a maximum PPD (e.g., a hardware-limited peak PPD) supported by the hardware of lenses 30 and/or prescription lenses 30RX, information identifying the curvatures and/or optical powers of lenses 30 and/or prescription lenses 30RX, sharpness information, distortion information, and/or any other desired optical information.

Optics information 104 may be generated during manufacture, assembly, testing, and/or calibration of device 10 and may be stored on device 10 for later reference. Additionally or alternatively, some or all of optics information 104 may be generated or updated during use of device 10 by an end user. In implementations where prescription lenses 30RX are removable lenses (e.g., clip-on lenses), optics information 104 may be updated in response to prescription lenses 30RX being installed on device 10. As one example, software on device 10 may instruct a user view a calibration chart or image and cameras on device 10 may perform measurements of how light propagates through prescription lenses 30RX to identify optics information 104 for the prescription lenses. As another example, prescription lenses 30RX may include a visual or electromagnetic indicator that identifies optics information 104 for the prescription lenses upon installation or that represent a unique identifier for the prescription lenses. Software on device 10 may then search an on-device (e.g., pre-calibrated) database of optics information and/or an off-device database (e.g., accessible via the Internet) for optics information 104 matching the unique identifier. As another example, the user of device 10 may provide a user input identifying the unique identifier to software running on device 10 and the software may search an on-device or off-device database of optics information for optics information 104 matching the unique identifier.

Context-aware rendering configurer 54 may generate a rendering frustrum size 108 for the renderer based on optics information 104 and/or eye position information 106. When configured using context-aware rendering configuration RCONFIG, renderer 56 may generate virtual content that is confined within a particular rendering window, sometimes also referred to as a rendering frustrum (e.g., without virtual content being rendered outside the rendering frustrum or with only virtual content greater than a predetermined resolution being rendered within the rendering frustrum). The rendering frustrum may have rendering frustrum size 108. Rendering frustrum size 108 corresponds to the minimum size for the rendering frustrum to cover the user's view given the hardware characteristics of optics 76 (optics information 104) and the user's eye position (eye position information 106).

Rendering frustrum size 108 may depend on the particular optical hardware configuration of device 10 (e.g., the optical characteristics of lenses 30 and optionally prescription lenses 30RX). For example, some lenses 30 or prescription lenses 30RX may exhibit superior optical performance for smaller rendering frustrum sizes 108 than other lenses 30 or prescription lenses 30RX. Rendering frustrum size 108 may also depend on eye position information 106. For example, a larger rendering frustrum size may be needed to fully display the virtual content to the user when the ER of eye 50 is lower than when the ER of eye 50 is higher. In general, larger rendering frustrum sizes may consume more power and rendering resources than smaller rendering frustrum sizes.

Context-aware rendering configurer 54 may also generate a pupil tracked geometrical PPD (gPPD) 110 for the renderer based on optics information 104 and/or eye position information 106. Pupil tracked gPPD 110 may depend on the particular optical hardware configuration of device 10 (e.g., the optical characteristics of lenses 30 and optionally prescription lenses 30RX). For example, some lenses 30 or prescription lenses 30RX may exhibit superior optical performance for different pupil tracked gPPDs 110 than other lenses 30 or prescription lenses 30RX. Pupil tracked gPPD 110 may also depend on eye position information 106.

Context-aware rendering configurer 54 may receive or identify binocular gaze information 112 from gaze tracking sensor(s) 70 over sensor data path 68 of FIG. 3. Binocular gaze information 112 may include information identifying the shape, location, and/or size of a binocular uncertainty zone 102 (FIG. 5) measured using gaze tracking sensor(s) 70, for example.

Context-aware rendering configurer 54 may also receive or identify an inter-SOC communication constraint 116. Inter-SOC communication constraint 116 may include, for example, a bandwidth constraint or limit associated with inter-SOC channel 60 between SOC 58-1 and SOC 58-2 (FIG. 3). Inter-SOC communication constraint 116 may, for example, be determined during manufacture, assembly, testing, and/or calibration of device 10 and may be stored on device 10 for later reference.

Context-aware rendering configurer 54 may generate a preliminary rendering configuration 114 based on binocular gaze information 112, inter-SOC communication constraint 116, rendering frustrum size 108, and/or pupil tracked gPPD 110. Preliminary rendering configuration 114 may identify and/or include an optimal maximum resolution (e.g., a peak resolution or PPD that exceeds the collective upper resolution limit of display(s) 14, optics 76, and any other hardware/software between renderer 56 and eye box 13), optimal foveal region size, optimal foveation curve, optimal rendering frustrum size, optimal pixel groupings (e.g., for low resolution zone(s)), etc., for the rendered virtual content to be produced by renderer 56 given rendering frustrum size 108 and pupil tracked gPPD 110 (e.g., given optics information 104 and eye position information 106), binocular gaze information 112 (e.g., the current binocular uncertainty zone 102), and given inter-SOC communication constraint 116 (e.g., given the bandwidth limit of inter-SOC communication channel 60).

Preliminary rendering configuration 114 (sometimes also referred to herein as optimal rendering configuration 114) may depend on optics information 104 and eye position information 106 (e.g., via rendering frustrum size 108 and pupil tracked gPPD 110), binocular gaze information 112, and inter-SOC communication constraint 116. Preliminary rendering configuration 114 may, for example, identify or include a higher peak PPD (e.g., for the foveated region of the rendered virtual content), a larger rendering frustrum size, a larger foveal region size, larger low resolution zone pixel groupings, etc., when inter-SOC communication constraint 116 is higher than when inter-SOC communication constraint 116 is lower.

As another example, preliminary rendering configuration 114 may, for example, identify or include a higher peak PPD (e.g., for the foveated region of the rendered virtual content), a smaller rendering frustrum size, and/or a lower foveal region size when binocular gaze information 112 identifies a smaller binocular uncertainty zone 102 than when binocular gaze information 112 identifies a larger binocular uncertainty zone 102 (e.g., power may be conserved by limiting the foveated zone of the rendered virtual content to binocular uncertainty zone 102, which may be smaller than each monocular uncertainty zone on its own).

Context-aware rendering configurer 54 may receive or identify display hardware constraints 120. Display hardware constraints 120 may be constraints of the display pipeline(s) and/or panel(s) in display(s) 14 such as a maximum resolution (PPD) supported by display(s) 14. Display hardware constraints 120 may, for example, identify a resolution degradation introduced by display(s) 14 to virtual content in the process of displaying the virtual content (e.g., in producing image light 37 of FIG. 3 that contains the virtual content). If desired, display hardware constraints 120 may include additional resolution constraints and/or degradations imparted by other software and/or hardware processing pipelines between renderer 56 and display(s) 14.

Context-aware rendering configurer 54 may also receive or identify content information 118 about the corresponding frame of virtual content to be rendered by renderer 56 and displayed by display(s) 14 (e.g., an array of image data pixel values collectively forming one or more virtual objects). The pixel pipeline in display(s) 14 operates in the pixel domain, which translates to different spectral or spatial frequencies as the rendering resolution changes. The system pixel pipeline can be defined as an impulse response that is a function of rendering resolution, for example. Content information 118 may include, for example, spectral information (e.g., frequency content across the frame of virtual content to be displayed) and/or meta data associated with the virtual content to be displayed. Some or all of content information 118 may be generated by one or more software applications running on device 10. Content spectral information may be identified or evaluated at runtime or may be precomputed as meta data if desired. The content spectral information may guide the maximum requiring rendering frequency needed to maintain image fidelity. Content with limited energy at higher frequencies can survive pixel pipeline re-sampling with minimal impact on content fidelity.

Preliminary rendering configuration 114 may represent the optimal, largest, and/or most resource-intensive foveated zone resolution, foveal zone size, rendering frustrum size, and low resolution zone pixel groupings supported by the system (e.g., display 14, software/hardware pipelines between renderer 56 and display 14, and optics 76) given optics information 104, eye position information 106, binocular gaze information 112, and inter-SOC communication constraint 116. If desired, context-aware rendering configurer 54 may adjust preliminary rendering configuration 114 based on display hardware constraints 120 and/or content information 118 to generate the context-aware renderer configuration RCONFIG supplied to renderer 56. Context-aware renderer configuration RCONFIG may, for example, include or identify a maximum PPD, foveated zone size, rendering frustrum size, and/or low resolution pixel grouping sizes that are less than that that of preliminary rendering configuration 114 to save power given display hardware constraints 120 and content information 118.

Consider one example in which optics 76 support a peak resolution of X PPD (e.g., as identified by optics information 104) and in which the hardware of display 14 deteriorates resolution by Y PPD while generating image light 37 (e.g., as identified by display hardware constraints 120). In this example, preliminary rendering configuration 114 may identify or include a peak resolution of Z=X+Y PPD for the foveated region of the rendered virtual content. In this way, after display 14 deteriorates the resolution of the virtual content by Y PPD, the virtual content still exhibits a peak resolution of X PPD, matching the hardware limit supported by display 14.

If, on the other hand, display 14 deteriorates resolution by W>Y PPD in generating image light 37 (e.g., as identified by display hardware constraints 120), preliminary rendering configuration 114 may identify or include a peak resolution of X+W PPD for the foveated region of the rendered virtual content, which would ensure that the virtual content is still displayed by display 14 with a foveated region having a maximum resolution of (X+W) PPD−W PPD=X PPD, matching the maximum resolution supported by the hardware limits of display 14.

However, if/when content information 118 indicates that the frame of virtual content itself includes less than a threshold amount of high frequency content (or content having a spatial or spectral frequency less than a threshold frequency), this may be indicative of the virtual content not actually needing to utilize all of its maximum resolution (e.g., because the virtual content does not include detailed features that would benefit from being viewed with as high a resolution as possible). As such, context-aware renderer configurer may generate context-aware renderer configuration RCONFIG that identifies a maximum resolution less than (X+W) PPD (in this example) and/or other settings to conserve power without detriment to user experience in viewing the virtual content.

Similarly, one or more software applications running on device 10 (e.g., a software application that supplies control signals or image data to renderer 56 for rendering virtual content) may include meta data with the frame (e.g., within content information 118) indicating to context-aware rendering configurer 54 that renderer 56 does not need to render the frame of virtual content with its maximum resolution in the foveated zone. As such, context-aware renderer configurer may generate context-aware renderer configuration RCONFIG that identifies a maximum resolution less than (X+W) PPD (in this example) and/or other settings to conserve power without detriment to user experience in viewing the virtual content. The meta data in content information 118 may include, for example, a flag indicating whether or not the frame of content includes text, detailed images, and/or other high frequency data that benefits from rendering at the maximum supported resolution in the foveated zone. Context-aware rendering configurer 54 may generate context-aware renderer configuration RCONFIG based on whether or not the flag is included in content information 118.

Context-aware rendering configurer 54 may configure renderer 56 (FIG. 3) using the settings of context-aware renderer configuration RCONFIG (e.g., a maximum PPD, rendering frustrum size, foveated zone size, low resolution pixel grouping size, etc.). Renderer 56 may render the frame of virtual content based on, using, and/or according to context-aware renderer configuration RCONFIG. Display(s) 14 may generate image light 37 that includes the rendered frame of (foveated) virtual content. Optics 76 may forward image light 37 to eye box 13. The rendered frame of (foveated) virtual content may be viewed in image light at 37 at eye box 14 in a manner that optimizes viewing performance given the current operating context of device 10 (e.g., given optics information 104, eye position information 106, binocular gaze information 112, inter-SOC communication constraint 116, display hardware constraints 120, and/or content information 118) while concurrently minimizing unnecessarily power consumption, which may also maximize battery life and/or minimize thermal heating for device 10.

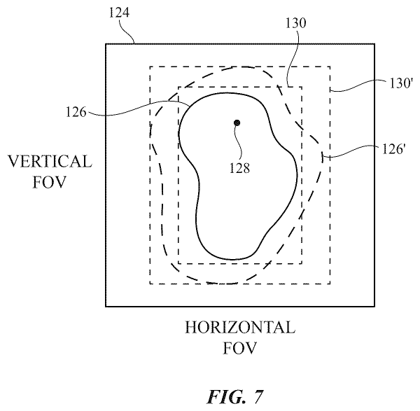

FIG. 7 shows a map of resolution (PPD) across angular field of view (FOV) 124 of eye box 13 that may be generated by context-aware rendering configurer 54, illustrating how preliminary rendering configuration 114 (FIG. 6) may vary depending on optics information 104, eye position information 106, and binocular gaze information 112. The horizontal axis of FIG. 7 plots locations or angles across the horizontal FOV of eye box 13. The vertical axis of FIG. 7 plots locations or angles across the vertical FOV of eye box 13.

In the example of FIG. 7, the user's gaze is in the direction of point 128 (e.g., as detected by gaze tracking sensor(s) 70 of FIG. 3 and identified or included in eye position information 106 of FIG. 6). Context-aware rendering configurer 54 may identify a maximum vertical PPD and a maximum horizontal PPD at point 128. The foveated region of the rendered frame of image data may overlap point 128 and may have the maximum vertical and/or horizontal PPD. In an implementation where optics 76 do not include prescription lenses 30RX, the frame of virtual content to be displayed may have a resolution (PPD) that exceeds a threshold resolution within region 126 around point 128. Context-aware rendering configurer 54 may generate a rendering frustrum 130 as the smallest rectangle that fits each point within region 126. Rendering frustrum 130 may have a corresponding size (e.g., rendering frustrum size 108 of FIG. 6).

In practice, the resolution profile (e.g., the shape and/or size of region 126) changes when optics 76 include prescription lens 30RX (FIGS. 1 and 3) and/or when the eye relief Z0 of eye 50 changes. For example, if a user attaches prescription lens 30RX to device 10 (e.g., as identified by optics information 104 of FIG. 6), region 126 may shift to an enlarged region 126′. Similarly, region 126 may shift to enlarged region 126′ if/when the user's eye relief Z0 (FIG. 5) decreases (e.g., as detected using gaze tracking sensor(s) 70 of FIG. 3 and identified in eye position information 106 of FIG. 6). Eye relief Z0 may decrease, for example, when the user moves their eye closer to optics 76 or when a different user having eyes that are more shallowly recessed in their skull starts using device 10. The addition of prescription lens 30RX and/or the reduction in eye relief Z0 may cause context-aware rendering configurer 54 to generate a larger rendering frustrum 130′ (e.g., enclosing enlarged region 126′). Conversely, removing prescription lens 30RX or increasing eye relief Z0 may shrink enlarged region 126′ to region 126 and may shrink larger rendering frustrum 130′ to rendering frustrum 130.

As one example, when eye relief Z0 is increased within a normal operating range in the absence of prescription lenses 30RX, there may be around a 1% increase in PPD within the 25 degrees around the center of FOV 124. As another example, when eye relief Z0 is increased within the normal operating range and myopic prescription lenses 30RX are added to device 10, there may be around a 12% increase in PPD within the 25 degrees around the center of FOV 124. The myopic prescription lenses 30RX may also increase PPD by around 12% at nominal distance 82 (FIG. 5) and/or may result in as much as a 25-35% increase in PPD at relatively long eye reliefs.

Considering the fixed number of rendered pixels, the optical stack, and eye box position (e.g., pupil tracked gPPD 110 of FIG. 6 and/or visible/usable FOV), the maximum resolution (PPD) in preliminary rendering configuration 114 (FIG. 6) can be adjusted to maintain the highest possible content fidelity. An eye box dependent rendering frustrum may lead to significant reduction in the required number of pixels/areas.

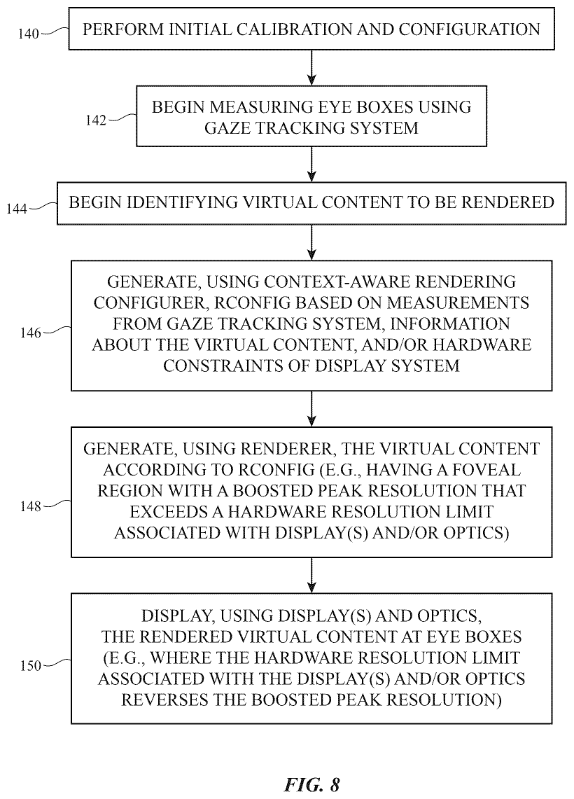

FIG. 8 is a flow chart of illustrative operations that may be performed by device 10 to display images (virtual content) at eye box 13 using gaze tracking sensor(s) 70, context-aware rendering configurer 54, and renderer 56 of FIG. 3.

At operation 140, device 10 may perform initial calibration and configuration. This may include generating, producing, and/or identifying some or all of optics information 104, display hardware constraints 120, and inter-SOC communication constraint 116 of FIG. 6. The initial calibration and configuration may be performed during manufacture/assembly of device 10 and/or after device 10 has been delivered to an end user. If desired, device 10 may update optics information 104 if/when a user attaches prescription lenses 30RX to device 10.

At operation 142, gaze tracking sensor(s) 70 may begin measuring eye boxes 13 using sensing light 74 and reflected light 72 (FIG. 3). Gaze tracking sensor(s) 70 may begin generating eye position information 106 and binocular gaze information 112 (FIG. 6) and may transmit the information to context-aware rendering configurer 54 over sensor data path 68. Gaze tracking sensor(s) 70 may continue to generate eye position information 106 and/or binocular gaze information 112 prior to, after, and/or concurrent with one or more of operations 144-150 of FIG. 8.

At operation 144, context-aware rendering configurer 54 may begin identifying frames of virtual content to be rendered. This may include, for example, receiving control signals, application calls, and/or image data from one or more software applications running on device 10 (e.g., an application that calls for the display of virtual content at eye boxes 13). Context-aware rendering configurer 54 may continue identifying frames of virtual content to be rendered prior to, concurrent with, and/or after one or more of operations 146-150 off FIG. 8.

At operation 146, context-aware rendering configurer 54 may generate (e.g., identify, compute, calculate, produce, output, etc.) a respective context-aware rendering configuration RCONFIG for use by renderer 56 in rendering each identified frame of virtual content. Context-aware rendering configurer 54 may generate each context-aware rendering configuration RCONFIG based on eye position information 106, binocular gaze information 112, optics information 104, inter-SOC communication constraint 116, display hardware constraints 120, and content information 118 associated with the corresponding frame of virtual content to be displayed. Context-aware rendering configurations RCONFIG may, for example, update or change over time as optics information 104 changes (e.g., as a user adds or removes prescription lenses 30RX from device 1), as eye position information 106 changes (e.g., as the user moves their eye relative to the eye box or as other uses wear device 10), as binocular gaze information 112 changes (e.g., as the user moves both of their eyes relative to each other), as display hardware constraints 120 change, as inter-SOC communication constraint 116 changes, and/or as content information 118 changes over time (e.g., for subsequent frames of virtual content). Context-aware rendering configurer 54 may transmit rendering configurations RCONFIG to renderer 56.

At operation 148, renderer 56 may generate frames of rendered virtual content according to, based on, or using the context-aware rendering configurations RCONFIG produced by context-aware rendering configurer 54 (e.g., context-aware rendering configurer 54 may configure renderer 56 to generate frames of virtual content pursuant to context-aware rendering configurations RCONFIG). The rendered frames of virtual content may, if desired, include frames of foveated virtual content having a maximum PPD, foveated region, rendering frustrum, low resolution pixel group setting, etc., that are given by the corresponding context-aware rendering configurations RCONFIG. This is illustrative. The rendered frames of virtual content need not be frames of foveated virtual content (e.g., the rendered frames of virtual content may have a constant PPD across the FOV of the frames). The rendered frames of virtual content may have a boosted peak resolution (e.g., within the foveated region when the virtual content is foveated content) that exceeds a collective hardware resolution limit of optics 76 (e.g., lenses 70 and optionally prescription lenses 30RX, as identified by optics information 104) and/or display(s) 14 (e.g., as identified by display hardware constraints 120). Renderer 56 may transmit the frames of virtual content to display(s) 14 (FIG. 3).

At operation 150, display(s) 14 may generate image light 37 that includes the rendered frames of virtual content. Optics 76 may direct image light 37 to eye boxes 13. The boosted peak resolution of the rendered frames of virtual content may be degraded by the hardware/software limitations of display(s) 14, optics 76, and any other hardware/software between renderer 56 and eye box 13 by the time image light 37 is received at eye boxes 13 (e.g., to the collective hardware resolution limit of display(s) 14, optics 76, and other hardware/software between renderer 56 and eye box 13). Put differently, degradations to resolution imparted by the hardware of display(s) 14, optics 76, and other hardware/software between renderer 56 and eye box 13 may reverse or cancel out the boosted peak resolution of the rendered virtual content to allow the virtual content to be viewed at the eye box at the maximum hardware resolution limit supported by display(s) 14, optics 76, and other hardware/software between renderer 56 and eye box 13.

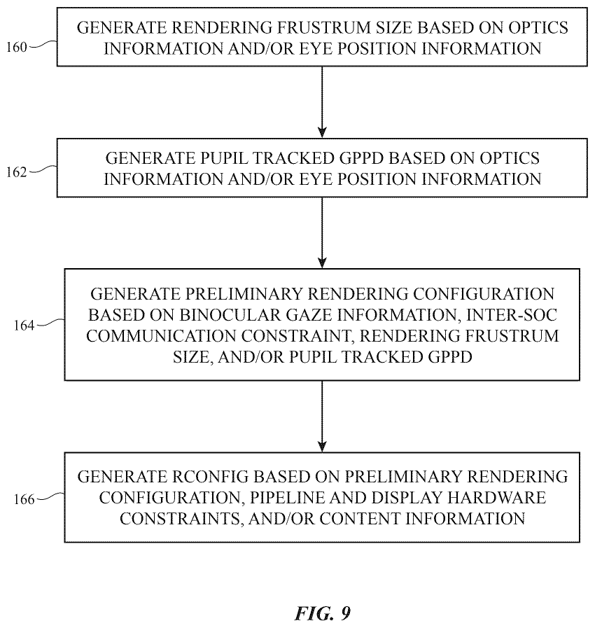

FIG. 9 is a flow chart of operations that may be performed by context-aware rendering configurer 54 to generate a context-aware rendering configuration RCONFIG for a corresponding frame of virtual content. The frame of virtual content may have corresponding content information 118 (FIG. 6). The operations of FIG. 9 may, for example, be performed while processing operation 146 of FIG. 8.

At operation 160, context-aware rendering configurer 54 may generate rendering frustrum size 108 based on optics information 104 and/or eye position information 106.

At operation 162, context-aware rendering configurer 54 may generate pupil tracked gPPD 110 (FIG. 6) based on optics information 104 and/or eye position information 106. Operation 162 may be performed prior to operation 160 or concurrent with operation 160.

At operation 164, context-aware rendering configurer 54 may generate preliminary rendering configuration 114 based on rendering frustrum size 108, pupil tracked gPPD 110, binocular gaze information 112, and/or inter-SOC communication constraint 116.

At operation 166, context-aware rendering configurer 54 may generate context-aware rendering configuration RCONFIG based on preliminary rendering configuration 114, display hardware constraints 120, and/or content information 118. Context-aware rendering configurer 54 may, for example, change one or more of the rendering frustrum size, foveated zone, low resolution pixel groupings, maximum PPD, etc., of preliminary rendering configuration 114 based on display hardware constraints 120 and/or content information 118 (e.g., to further reduce power consumption on device 10).

Consider an example in which a user's eye is located at horizontal position X0, vertical position Y0, and eye relief Z0 at eye box 13 and in which the user adds removable myopic prescription lens 30RX to device 10. The prescription lens may shift the optimal hardware location for the highest PPD for rendered foveated content. In this example, device 10 may identify (e.g., at operation 140 of FIG. 8) the particular prescription lens 30RX added to device 10 (e.g., based on a user input and/or identifying information included on the prescription lens and detected by device 10). Device 10 may identify optics information 104 for identified prescription lens 30RX and/or the combination of lenses 30 with prescription lens 30RX in the optical stack of device 10 (e.g., distortion information associated with the lenses, sharpness information associated with the lenses, optical powers associated with the lenses, etc.).

Gaze tracking sensor(s) 70 may then detect the user's horizontal position X0, vertical position Y0, and eye relief Z0 (e.g., while processing operation 142 of FIG. 8). Context-aware rendering configurer 54 may generate a map of the resolution (PPD) distribution for the rendered frame of virtual data as a function of angular position across the FOV 124 of eye box 13 (FIG. 7) based on horizontal position X0, vertical position Y0, and/or eye relief Z0 (e.g., while processing operation 162 of FIG. 9). Context-aware rendering configurer 54 may generate a rendering frustrum 130 based on the map of the PPD distribution (e.g., fitting around region 126 in FIG. 7, while processing operation 160 of FIG. 9). Context-aware rendering configurer 54 may identify the maximum PPD for preliminary rendering configuration 114 from the map. Context-aware rendering configurer 54 may adjust the foveated region size and/or shape based on binocular gaze information 112 (e.g., to reduce power) and/or may reduce one or more settings of preliminary rendering configuration 114 to meet inter-SOC communication constraint 116 (e.g., while processing operation 164 of FIG. 9). Context-aware rendering configurer 54 may adjust preliminary rendering configuration 114 to compensate for display hardware constraints 120 and/or to reduce power consumption based on content information 118, generating a final context-aware rendering configuration RCONFIG for renderer 56 (e.g., while processing operation 166 of FIG. 9).

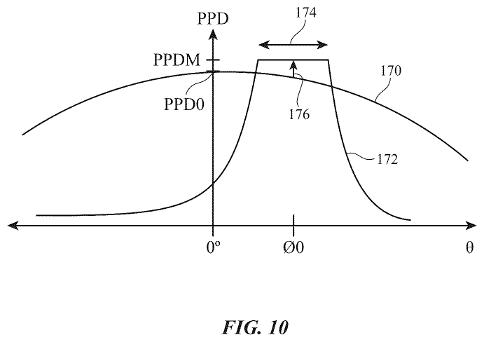

FIG. 10 is a plot showing the resolution (PPD) as a function of angle θ across 124 (FIG. 7) for a frame of foveated virtual content rendered by renderer 56 based on a corresponding context-aware rendering configuration RCONFIG. Curve 172 of FIG. 10 plots the resolution of the frame of foveated virtual content at different angles θ. As shown by curve 172, the frame of foveated virtual content may have a foveated region 174 that spans a range of angles θ around a corresponding gaze angle θ0 (e.g., as identified by eye position information 106 of FIG. 6). Foveated region 174 may have a corresponding angular size (width) around gaze angle θ0. The foveated frame of virtual content has a peak resolution PPDM within foveated region 174. The resolution of the foveated frame of virtual content drops from peak resolution PPDM outside of foveated region 174. Curve 172 (sometimes also referred to as a foveation curve or profile), the location and/or width of foveated region 174, and/or peak resolution PPDM may be specified by context-aware rendering configuration RCONFIG (e.g., context-aware rendering configuration RCONFIG may configure renderer 56 to output a frame of rendered virtual content characterized by curve 172).

Curve 170 represents the maximum resolution limit supported by the hardware of display 14 and/or optics 76. As shown by curve 170, display 14 and/or optics 76 may support no more than a peak resolution of PPD0 around a center of the FOV, with the peak resolution decreasing even further at angles away from the center of the FOV (e.g., due to off-axis roll-off by optics 76). Put differently, display 14 may generate image light 37 and optics 76 may direct image light 37 to eye box 13 such that the virtual content included in image light 37 has a resolution no greater than peak resolution PPD0 across the FOV. As shown by curves 172 and 170, renderer 56 may generate the frame of rendered virtual content with a peak resolution PPDM within foveated region 174 that exceeds the hardware-constrained peak resolution PPD0 of display(s) 14 and/or optics 76 by margin 176. The particular margin 176 set by the context-aware renderer configuration may depend on the current user gaze angle, for example. While this may cause renderer 56 to consume slightly more power than strictly limiting the peak resolution of the frame of virtual content to the hardware-constrained peak resolution PPD0 of display(s) 14 and/or optics 76 within foveated region 174, margin 176 may serve to prevent the rendered frame of virtual content from being received at eye box 14 at a peak resolution less than peak resolution PPD0 within foveated region 174 even after the hardware constraints of display(s) 14 and optics 76 have degraded the resolution of the frame of virtual content in generating and redirecting image light 74. Curves 170 and 172 may have other shapes in practice.

The methods and operations described above in connection with FIGS. 1-10 may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., the storage circuitry within control circuitry 20 of FIG. 2). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., one or more processors in control circuitry 20 of FIG. 2). The processing circuitry may include microprocessors, application processors, digital signal processors, central processing units (CPUs), application-specific integrated circuits with processing circuitry, or other processing circuitry.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

System 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. A method of operating an electronic device, comprising:
with a gaze tracking sensor, generating eye position information associated with an eye box;
with a renderer, rendering virtual content having a peak resolution based on the eye position information;
with a display, generating light that includes the rendered virtual content; and
with optics, directing the light to the eye box, wherein the display and the optics collectively exhibit a resolution limit, the peak resolution exceeds the resolution limit, and at least the display and the optics decrease the peak resolution of the rendered virtual content to a magnitude at the eye box that is less than or equal to the resolution limit.

2. The method of claim 1, wherein the display degrades a resolution of the rendered virtual content by a predetermined amount in generating the light and wherein the peak resolution exceeds the resolution limit by a margin greater than or equal to the predetermined amount.

3. The method of claim 1, wherein the eye position information comprises an eye relief, the peak resolution being based on the eye relief.

4. The method of claim 1, further comprising:
with the renderer, adjusting the peak resolution responsive to attachment of a prescription lens to the optics; and
with the prescription lens, directing the light from the optics to the eye box.

5. The method of claim 1, further comprising:
with one or more processors, generating a rendering configuration based on the eye position information, wherein rendering the virtual content comprises rendering the virtual content according to the rendering configuration.

6. The method of claim 5, wherein generating the rendering configuration comprises:
generating the rendering configuration based on an optical characteristic of the optics.

7. The method of claim 6, wherein generating the rendering configuration further comprises:
generating a rendering frustrum size for the rendering configuration based on the optical characteristic of the optics and the eye position information; and
generating a pupil tracked geometric pixels per degree (gPPD) value based on the optical characteristic of the optics and the eye position information.

8. The method of claim 7, wherein the renderer is implemented on at least a first system on chip (SOC) and a second SOC coupled to the first SOC over an inter-SOC channel, wherein generating the rendering configuration further comprises:
generating the rendering configuration based on the rendering frustrum size, the pupil tracked gPPD value, binocular gaze information generated by the gaze tracking sensor, and a bandwidth limit of the inter-SOC channel.

9. The method of claim 8, wherein generating the rendering configuration further comprises:
updating the rendering configuration based on hardware information about the display and information about the virtual content.

10. The method of claim 9, wherein the information about the virtual content comprises meta data associated with the virtual content.

11. The method of claim 9, wherein the information about the virtual content comprises spectral information about the virtual content.

12. The method of claim 1, wherein the renderer comprises a first system on chip (SOC) and a second SOC coupled to the first SOC over an inter-SOC channel, the peak resolution being based on a bandwidth limit of the inter-SOC channel.

13. The method of claim 1, wherein rendering the virtual content comprises:
reducing the peak resolution based on spectral information or meta data associated with the virtual content.

14. The method of claim 1, wherein the rendered virtual content comprises a frame having a foveated region with the peak resolution and having a rendering frustrum size, the foveated region and the rendering frustrum size being based on the eye position information.

15. The method of claim 14, further comprising:
with an additional gaze tracking sensor, generating additional eye position information associated with an additional eye box; and
with the one or more processors, identifying a binocular uncertainty zone based on the eye position and the additional eye position, wherein the foveated region in the rendered virtual content is based on the binocular uncertainty zone.

16. A method of operating an electronic device, comprising:
with a gaze tracking sensor, identifying an eye relief associated with an eye box;
with a renderer, rendering a frame of virtual content having a foveated region that is based on the eye relief, the foveated region having a resolution;
with a display, generating light that includes the frame of virtual content; and
with optics, directing the light to the eye box, wherein at least the display and the optics collectively exhibit an upper resolution limit and wherein the resolution of the foveated region in the rendered frame of virtual content exceeds the upper resolution limit.

17. The method of claim 16, further comprising:
with the gaze tracking sensor, identifying a vertical pupil position and a horizontal pupil position for the eye box, wherein the foveated region is based on the vertical pupil position and the horizontal pupil position.

18. The method of claim 16, wherein rendering the frame of virtual content comprises rendering the frame of virtual content within a rendering frustrum having a rendering frustrum size that is based on the eye relief and information about the optics.

19. A method of operating an electronic device, comprising:
with a display, generating light that includes a frame of virtual content, the frame of virtual content including a foveated region;
with a lens, directing the light towards a removable prescription lens;
with the removable prescription lens, directing the light towards an eye box;
with a renderer, rendering the frame of virtual content based on one or more characteristics of the removable prescription lens, wherein at least the display, the lens, and the removable lens collectively exhibit an upper resolution limit; and
with the renderer, providing the rendered frame of virtual content to the display with a resolution in the foveated region that exceeds the upper resolution limit.

20. The method of claim 19, further comprising:
with a gaze tracking sensor, identifying an eye relief associated with the eye box, wherein rendering the frame of virtual content comprises rendering the foveated region based on the eye relief and at least one optical characteristic of the prescription lens.
